(19) United States
(12) Patent Application Publication
(10) Pub. No.: US 2022/0291954 A1
(43) Pub. Date: Sep. 15, 2022

(54) Computer System and Field Operation Supporting Method

(71) Applicant: Hitachi, Ltd., Tokyo (JP)

(72) Inventors: Shin TEZUKA, Tokyo (JP); Yoji OZAWA, Tokyo (JP)

(21) Appl. No.: 17/592,742

(22) Filed: Feb. 4, 2022

(30) Foreign Application Priority Data
Mar. 9, 2021 (JP) 2021-037750

(51) Int. Cl. G06F 9/48; H04N 5/232; H04N 5/247; G16Y 20/10; G16Y 40/35

(52) U.S. Cl. CPC G06F 9/4881; H04N 5/23206; H04N 5/247; G16Y 20/10; G16Y 40/35

(57) ABSTRACT

A field operation computer includes a field operation unit, a task management unit, and a data management unit that retains configuration information indicating a relationship between a sensor and a monitored area. The field operation unit collects acquired sensor information in order to monitor the monitored area by the sensor. The task management unit generates field status prediction information including prediction information of an activity indicating a degree to which a status in which the sensor information is not collectable from the sensor influences the monitoring of the monitored area, and controls a timing at which the task is executed based on the field status prediction information and the configuration information.

### BACKGROUND OF THE INVENTION

### 1. Field of the Invention

The present invention relates to a computer system and a method that supports operation management of a sensor in a field.

### 2. Description of the Related Art

In recent years, a technology called the Internet of Things (IoT) has been attracting attention as a technology for connecting various devices such as various sensors to the Internet, and the number of cases where data collected by using the IoT is used for various services has been increased. For example, as epidemic measures and crime prevention measures in commercial stores and public facilities, an IoT system that includes IoT devices using sensors such as light detection and ranging (LiDAR) and cameras and edge computers for managing the IoT devices has been introduced, and services that provide people flow analysis and measures based on information collected from each IoT device have been attracting attention.

In an operation of the IoT system installed in a field, it is essential to regularly execute tasks for security measures and maintenance works such as update processing of firmware and software of the edge computers for connecting the IoT devices to the Internet and calibration processing of various sensors. In order to regularly execute these tasks, it is necessary to stop the system as planned, and a data loss may occur during the execution of the task. Note that, although measures to take manual alternative means for missing data are considered, since a great deal of time and money are required, the measures cannot be easily adopted. Further, in an IoT system that needs to continue operating 24 hours a day, 365 days a year, such as a system used for the crime prevention measures in the public facilities such as airports, it is necessary to execute tasks while the service is continued.

Accordingly, for the IoT system installed in the field, a mechanism that can execute necessary tasks while data loss and service outages are prevented is required. For example, US2018/0376110A is known as a technology related to this mechanism.

### SUMMARY OF THE INVENTION

In the technology disclosed in US2018/0376110A, a status in which video data of a surveillance camera is lost even during a failure or maintenance is prevented by forming a cluster of a plurality of recording servers. However, in order to realize the method of US2018/0376110A, means for forming a cluster configuration by the recording servers, cooperating the surveillance camera with two or more recording servers, and changing a transmission destination of the video data when there is a possibility of loss is required. That is, for example, when the surveillance camera or sensor does not have a function of switching between the recording servers to which the data is transmitted without stopping, or when it is necessary to stop the transmission of the data for calibration of the surveillance camera or sensor, there is a problem that the loss of the data including information on a monitored area in the field is not avoided.

The present invention has been made in view of the above problems, and an object of the present invention is to appropriately control a timing at which a task is executed for a sensor installed in a field.

A computer system according to the present invention includes a field operation unit that performs operation management of one or a plurality of sensors installed in a field having one or a plurality of monitored areas in order to monitor the monitored area in the field, a task management unit that manages a task to be executed for the sensor, and a data management unit that retains configuration information indicating a relationship between the sensor and the monitored area. The field operation unit collects sensor information acquired in order to monitor the monitored area by the sensor, and the task management unit that generates field status prediction information including prediction information of an activity indicating a degree to which a status in which the sensor information is not collectable from the sensor influences the monitoring of the monitored area, and controls a timing at which the task is executed based on the field status prediction information and the configuration information.

A field operation supporting method according to the present invention is a method for supporting operation management of one or a plurality of sensors installed in a field having one or a plurality of monitored areas in order to monitor the monitored area in the field. The method includes retaining configuration information indicating a relationship between the sensor and the monitored area, generating field status prediction information including prediction information of an activity indicating a degree to which a status in which sensor information is not collectable from the sensor influences the monitoring of the monitored area, and controlling a timing at which a task related to the sensor is executed based on the field status prediction information and the configuration information.

According to the present invention, it is possible to appropriately control the timing at which the task is executed for the sensor installed in the field.

### BRIEF DESCRIPTION OF THE DRAWINGS

FIG. 1 is a diagram illustrating a configuration of an IoT system according to an embodiment of the present invention;

FIG. 2 is a diagram illustrating a configuration example of a field operation computer;

FIG. 3 is a diagram illustrating an example of configuration information;

FIG. 4 is a diagram illustrating an example of task information;

FIG. 5 is a diagram illustrating an example of field status history information;

FIG. 6 is a diagram illustrating an example of a field status prediction model;

FIG. 7 is a diagram illustrating an example of field status prediction information;

FIG. 8 is a flowchart illustrating a flow of overall processing of the field operation computer;

FIG. 9 is a flowchart illustrating a flow of processing of a task management unit of the field operation computer; and

FIG. 10 is a diagram illustrating an example of a task management screen provided by the field operation computer.

### DESCRIPTION OF THE PREFERRED EMBODIMENTS

Hereinafter, an embodiment of the present invention will be described with reference to the drawings. Note that, the embodiment and the drawings to be illustrated below are one of forms for implementing the present invention, and do not limit application to other configurations and forms capable of executing the same processing.

An IoT system described in the present embodiment is a system that realizes crime prevention, epidemic prevention, and sales improvement in shopping centers by monitoring a flow of people coming and going on a floor with sensors such as LiDAR and cameras installed in a shopping center and utilizing obtained sensor data for a people flow visualization service or the like. Services provided by this IoT system are realized by computers operating on a cloud, and the sensor data obtained by the sensors is provided to the computers that provide the services via edge computers installed in a field and the Internet.

In general, the edge computers and the sensors included in the IoT system need to perform regular maintenance tasks, for example, application of security patches to an operating system (OS) and regular updating of programs that manage the sensors. In addition, the sensors such as LiDAR need to perform regular maintenance tasks such as calibration in order to maintain the monitoring accuracy of the people flow. However, it is necessary to stop the edge computers or the sensors as the execution target during the execution of such tasks. Thus, the IoT system according to the present embodiment minimizes the influence on the service provided by the IoT system by controlling an execution timing of the task for the edge computer or the sensor as will be described later.

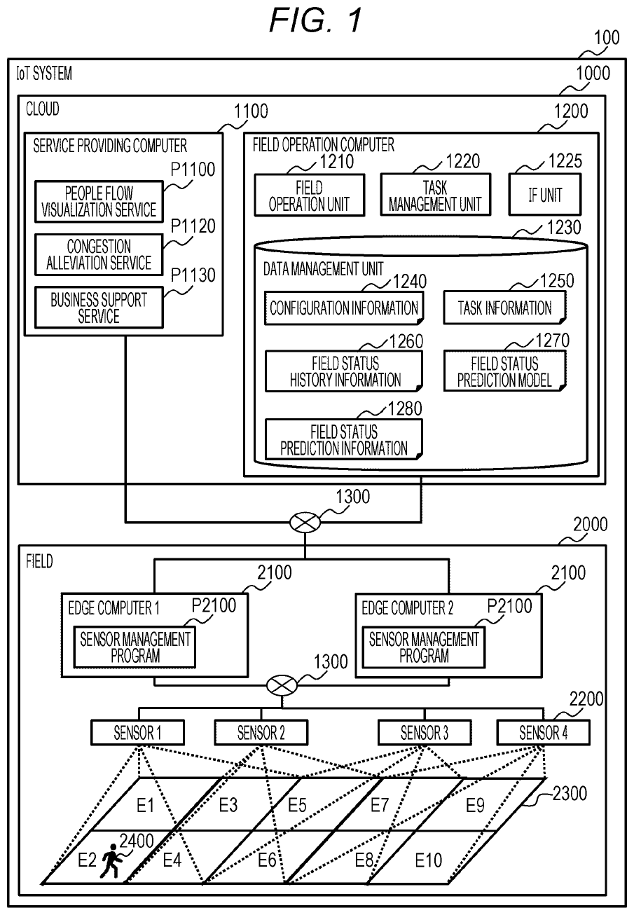

FIG. 1 is a diagram illustrating a configuration of the IoT system according to the embodiment of the present invention. An IoT system 100 illustrated in FIG. 1 includes a cloud 1000 and a field 2000. The cloud 1000 includes a service providing computer 1100 that provides various services to users and a field operation computer 1200. The field 2000 has edge computers 2100, sensors 2200, and monitored areas 2300 divided as areas E1 to E10.

The field 2000 is a monitoring target location by the sensors 2200, and corresponds to, for example, an inside of a facility of a shopping center. One or a plurality of sensors 2200 is installed in the field 2000 in order to monitor the monitored areas 2300. The service providing computer 1100 can monitor the monitored areas 2300 based on sensor information collected by the sensors 2200, and can provide various services to the users based on the monitoring result.

Note that, although FIG. 1 illustrates an example in which two edge computers 2100 are installed in the field 2000 and four sensors 2200 are connected to these edge computers 2100 via a network 1300, the number of edge computers 2100 and the number of sensors 2200 installed in the field 2000 are not limited thereto. Further, although FIG. 1 illustrates an example in which the monitored area 2300 is divided into ten areas E1 to E10, the number of monitored areas 2300 set in the field 2000 is not limited thereto. That is, in the IoT system 100 according to the present embodiment, each of the edge computers 2100, the sensors 2200, and the monitored areas 2300 can be set in any number in the field 2000.

The service providing computer 1100 includes, for example, a CPU, a ROM, a RAM, and the like, and provides various services to the users by executing predetermined programs by the CPU. For example, a people flow visualization service P1100 that visualizes a people flow, a congestion alleviation service P1110 that proposes measures for alleviating congestion, and a business support service P1130 that recommends the optimal arrangement of product stores suitable for improvement of sales of articles from information on the people flow can be provided to the users who use the IoT system 100.

The field operation computer 1200 includes a field operation unit 1210, a task management unit 1220, an interface (IF) unit 1225, and a data management unit 1230.

The field operation unit 1210 operates and manages the sensors 2200 installed in the field 2000. The field operation unit 1210 collects sensor information transmitted from the sensors 2200 via the edge computers 2100, and generates field status history information 1260 based on the sensor information. The field status history information 1260 generated by the field operation unit 1210 is stored and retained in the data management unit 1230.

The task management unit 1220 manages tasks to be executed for the sensors 2200 installed in the field 2000. The task management unit 1220 predicts activities of the monitored areas 2300 at a specific time in the future based on the field status history information 1260 and a field status prediction model 1270 stored and retained in the data management unit 1230, and generates field status prediction information 1280. Note that, the activity of the monitored area 2300 indicates a degree to which a status in which the sensor information is not collectable from the sensor 2200 influences the monitoring of the monitored area 2300, and is expressed by, for example, a people flow status in the monitored area 2300. The execution of the task for the edge computer 2100 or the sensor 2200 is managed based on the generated field status prediction information 1280, and configuration information 1240 and task information 1250 stored and retained in the data management unit 1230.

The IF unit 1225 executes communication processing for the field operation computer 1200 to communicate with the service providing computer 1100 and the edge computers 2100. Further, it is possible to provide a predetermined management screen to a system administrator who manages the IoT system 100, and it is also possible to reflect contents input by the system administrator on this management screen in each information of the data management unit 1230.

The data management unit 1230 stores and retains various kinds of information necessary for an operation of the field operation computer 1200. The data management unit 1230 stores, for example, the configuration information 1240, the task information 1250, the field status history information 1260, the field status prediction model 1270, the field status prediction information 1280, and the like.

The edge computer 2100 transmits the sensor information acquired by the sensor 2200 to the service providing computer 1100 and the field operation computer 1200. Each edge computer 2100 is associated with one or a plurality of sensors 2200, and performs relay processing when the sensor information acquired by the corresponding sensor 2200 is transmitted to the service providing computer 1100 or the field operation computer 1200. Note that, the edge computer 2100 has a management function of stopping, restarting the sensor 2200, and changing an affiliation of the sensor 2200 to another edge computer 2100, and a function of fabricating the sensor information. The edge computer 2100 includes, for example, a CPU, a ROM, a RAM, and the like, and realizes these functions by executing a sensor management program P2100 by the CPU.

The sensor 2200 monitors one or a plurality of monitored areas 2300 and acquires sensor information corresponding to a status of the monitored area 2300. As the sensor 2200, a LiDAR or a camera can be used in order to monitor the people flow in each monitored area 2300 by using, for example, infrared rays or visible light and to detect a person 2400 present in the monitored area 2300. Further, in order to monitor an environment of each monitored area 2300, a temperature sensor, a humidity sensor, or the like may be used as the sensor 2200. In addition to these sensors, any type of sensor can be used as the 2200 as long as the sensor can monitor the monitored areas 2300 and acquire the sensor information required for the service provided by the service providing computer 1100 to the user according to the monitoring result.

The monitored area 2300 is a monitoring target location of the IoT system 100 in the field 2000, and corresponds to, for example, a floor in a shopping center. The monitored areas 2300 have the areas E1 to E10 divided in a grid pattern. Note that, the monitored area 2300 may not be divided in the grid pattern. For example, the monitored area may be expressed by two-dimensional coordinates such as a circle or a polygon, or may be expressed by three-dimensional coordinates such as a sphere or a cube. Alternatively, the shape and size of the monitored area 2300 may be expressed by using an identifier. In these cases, coordinate values of each area constituting the monitored areas 2300 may be continuous values or discrete values, or may be expressed by a mathematical formula.

Note that, the edge computers 2100 and the sensors 2200 installed in the field 2000 are connected to each other via the network 1300. Further, each edge computer 2100 transmits the sensor information acquired by the sensor 2200 to the service providing computer 1100 and the field operation computer 1200 via the network 1300. The network 1300 includes, for example, the Internet, a local area network (LAN), a virtual private network (VPN), and the like. The network 1300 may include a device such as a network switch. Further, when the edge computers 2100 and the sensors 2200 can communicate with each other, communication may be performed not via the network 1300.

Although FIG. 1 illustrates an example in which the service providing computer 1100 and the field operation computer 1200 are arranged in the cloud 1000 and the edge computers 2100 are arranged in the field 2000, the arrangement of these computers can be changed arbitrarily. For example, the service providing computer 1100 and the field operation computer 1200 may be distributed and arranged in the cloud 1000 and the field 2000, respectively. Further, a part or all of the edge computers 2100 may be arranged in the cloud 1000.

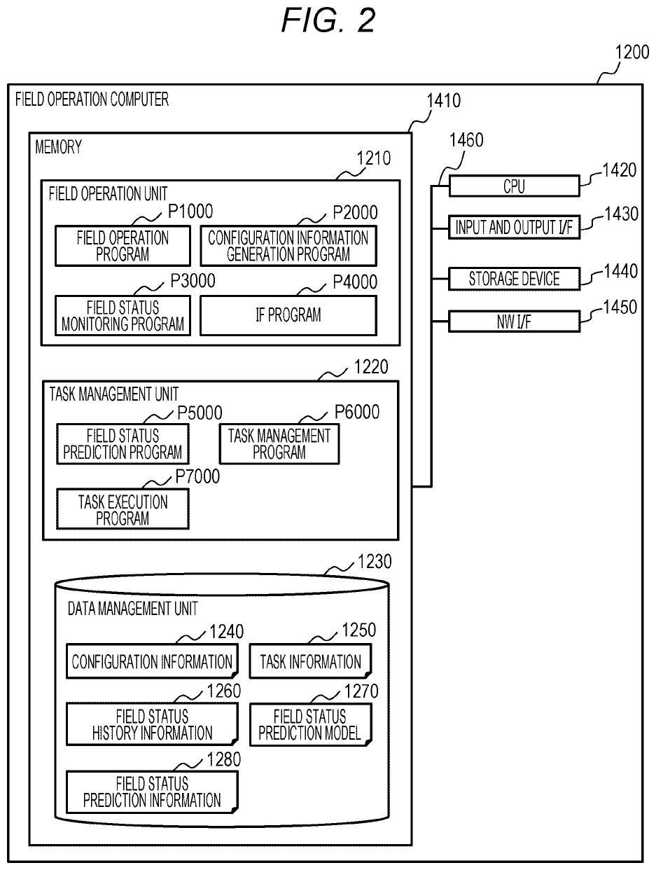

FIG. 2 is a diagram illustrating a configuration example of the field operation computer 1200. The field operation computer 1200 includes a memory 1410, a CPU 1420, an input and output I/F 1430, a storage device 1440, and a network I/F 1450, and these components are connected to each other by an internal bus 1460.

The memory 1410 includes, as programs for realizing the field operation unit 1210, a field operation program P1000, a configuration information generation program P2000, a field status monitoring program P3000, and an IF program P4000. Further, the memory includes, as programs for realizing the task management unit 1220, a field status prediction program P5000, a task management program P6000, and a task execution program P7000. These programs are stored in the storage device 1440, for example, and are executed in the CPU 1420 by being read from the storage device 1440 and loaded in the memory 1410. As a result, the CPU 1420 can operate as the field operation unit 1210 and the task management unit 1220.

Further, the memory 1410 includes the data management unit 1230. As described with reference to FIG. 1, the data management unit 1230 stores the configuration information 1240, the task information 1250, the field status history information 1260, the field status prediction model 1270, and the field status prediction information 1280. Note that, the details of each information will be described later.

The field operation program P1000 has a function of controlling the overall IoT system 100 including the field operation computer 1200.

The configuration information generation program P2000 has a function of generating the configuration information 1240 indicating a relationship between the edge computers 2100, the sensors 2200, and the monitored areas 2300 and recording the configuration information in the data management unit 1230. Information for generating the configuration information 1240 may be collected from, for example, the edge computers 2100, or input information from the system administrator may be collected to generate the configuration information 1240.

The field status monitoring program P3000 has a function of generating the field status history information 1260 based on the sensor information transmitted from the sensors 2200 via the edge computers 2100 and recording the field status history information in the data management unit 1230. Further, the field status monitoring program may have a function of generating activity information of the monitored areas 2300 at a specific time, for example, the field status prediction model 1270 for predicting the people flow status and the like and recording the activity information in the data management unit 1230 based on the generated field status history information 1260.

The IF program P4000 has a function of providing an input and output screen as a user interface for the system administrator. This input and output screen may be displayed on a display device included in the input and output I/F 1430, or may be output from the field operation computer 1200 to another computer via the network 1300.

The field status prediction program P5000 has a function of predicting the activities of the monitored areas 2300 at a specific time in the future from the field status history information 1260 by using the field status prediction model 1270, generating the field status prediction information 1280 corresponding to the prediction result, and recording the field status prediction information in the data management unit 1230.

The task management program P6000 has a function of determining a timing at which the task is to be executed from the information on the tasks for the edge computers 2100 or the sensors 2200 recorded in the task information 1250 and the field status prediction information 1280, and updating the task information 1250 based on the determination result. At this time, a connection relationship between the edge computer 2100 and the sensor 2200 may be changed as needed.

The task execution program P7000 has a function of executing each task based on the execution timing and the task content of each task recorded in the task information 1250. Note that, when the connection relationship between the edge computer 2100 and the sensor 2200 is planned to be changed as described above, the task may be executed after the connection relationship between the edge computer 2100 and the sensor 2200 is changed according to the plan.

The CPU 1420 executes each program read from the storage device 1440 and loaded in the memory 1410. The storage device 1440 is a non-volatile storage medium such as a hard disk drive (HDD) or a solid state drive (SSD). Note that, in the field operation computer 1200, the storage device 1440 is not an essential component, and for example, an external storage device or the like may be used instead of the storage device 1440.

The input and output I/F 1430 is a user interface with the system administrator, and includes an input device such as a keyboard and a mouse, and an output device such as a display. The network I/F 1450 executes predetermined communication interface processing for the field operation computer 1200 to communicate with the service providing computer 1100 or the edge computers 2100 via the network 1300, and is, for example, a network interface card (NIC) or the like. Note that, a technology such as Secure Shell (SSH) may be applied to the network I/F 1450 such that the field operation computer 1200 can be remotely controlled via the network 1300. In this case, the input and output I/F 1430 is not an essential component in the field operation computer 1200.

Note that, although FIG. 2 illustrates a configuration example of the field operation computer 1200, the service providing computer 1100 and the edge computer 2100 can also have the same hardware configuration. Further, these computers may be physical computers or virtual computers operating on the physical computers.

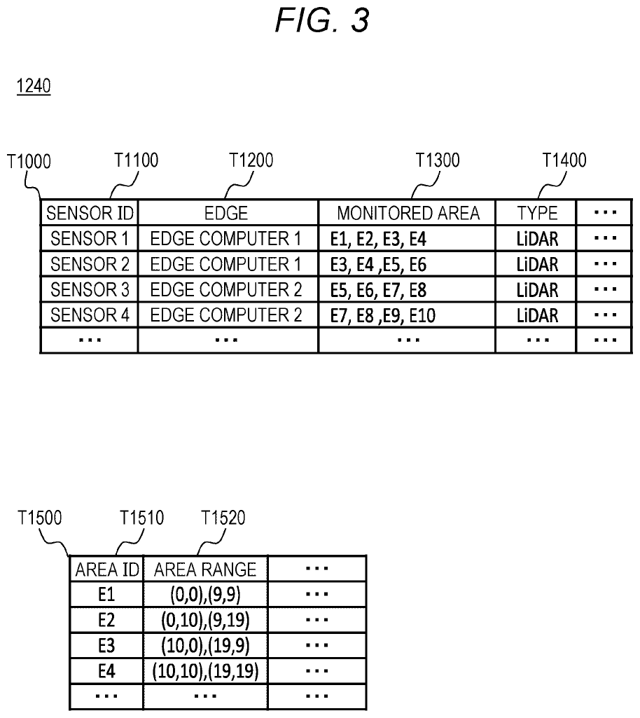

FIG. 3 is a diagram illustrating an example of the configuration information 1240. The configuration information 1240 includes, for example, a configuration table T1000 and a monitored area table T1500.

The configuration table T1000 includes information illustrating the relationship between the edge computer 2100, the sensor 2200, and the monitored area 2300, and is referred to and updated by the field operation program P1000. Each record of the configuration table T1000 is set for each sensor 2200 installed in the field 2000, and has information corresponding to each column of a sensor ID T1100, an edge T1200, a monitored area T1300, and a type T1400.

The sensor ID T1100 is an identifier for uniquely identifying each sensor 2200. Each sensor 2200 is given a unique identifier such as “1” or “2” in advance. Information indicating the identifier for each sensor is stored in the sensor ID T1100. Note that, hereinafter, in order to distinguish between and describe the sensors 2200, the sensors may be referred to as a “sensor 1”, a “sensor 2”, and the like according to the identifier given to each sensor 2200.

The edge T1200 is an identifier of the edge computer 2100 as a data transmission destination of each sensor 2200. Each edge computer 2100 is given a unique identifier such as “1” or “2” in advance. The information on the edge computer 2100 that relays data when each sensor 2200 transmits the sensor information to the service providing computer 1100 and the field operation computer 1200 is stored in the edge T1200 by using the identifier for each edge computer. Note that, hereinafter, in order to distinguish between and describe the edge computers 2100, the edge computers may be referred to as an “edge computer 1”, an “edge computer 2”, and the like according to the identifier given to each edge computer 2100.

The monitored area T1300 is an identifier of the monitored area 2300 as a monitoring target by each sensor 2200 in the field 2000. Each monitored area 2300 is given a unique identifier such as “E1” or “E2” in advance according to the above-mentioned area division. Information on the monitored area 2300 as the monitoring target by each sensor 2200 is stored in the monitored area T1300 by using the identifier for each monitored area. Note that, hereinafter, in order to distinguish between and describe the monitored areas 2300, the monitored areas may be referred to as a “monitored area E1”, a “monitored area E2”, and the like according to the identifier given to each monitored area 2300.

The type T1400 is information indicating a type of each sensor 2200, and examples thereof include a LiDAR, a temperature sensor, a humidity sensor, and a camera.

The monitored area table T1500 includes information on a range of the monitored area 2300 in a physical space, and which is referenced and updated by the field operation program P1000. Each record of the monitored area table T1500 is set for each monitored area 2300, and has information corresponding to each column of an area ID T1510 and an area range T1520. Note that, the contents of the monitored area table T1500 may be input by the user through a screen.

The area ID T1510 is an identifier for uniquely identifying each monitored area 2300, and corresponds to the information stored in the monitored area T1300 of the configuration table T1000. That is, information indicating the unique identifier such as “E1” or “E2” given to each monitored area 2300 according to the above-mentioned area division is stored in the area ID T1510.

The area range T1520 is information indicating a range of each monitored area 2300. The range of each monitored area 2300 is expressed by plane coordinates defined by, for example, dividing the floor of the shopping center into a grid pattern. In this case, a value of the plane coordinates indicating the range of each monitored area 2300 is stored in the area range T1520. Note that, the range of each monitored area 2300 described in the area range T1520 is not limited to the expression by the plane coordinates, and may be expressed in another form. For example, a circle, a polygon, or the like expressed by two-dimensional coordinates, or a sphere, a cube, or the like expressed by three-dimensional coordinates may be used as the range of the monitored area 2300. Further, the coordinate values described in the area range T1520 may be either continuous values or discrete values, or may be expressed by a mathematical formula or the like. In addition to these expression forms, the information indicating the range of each monitored area expressed in any expression format can be stored in the area range T1520.

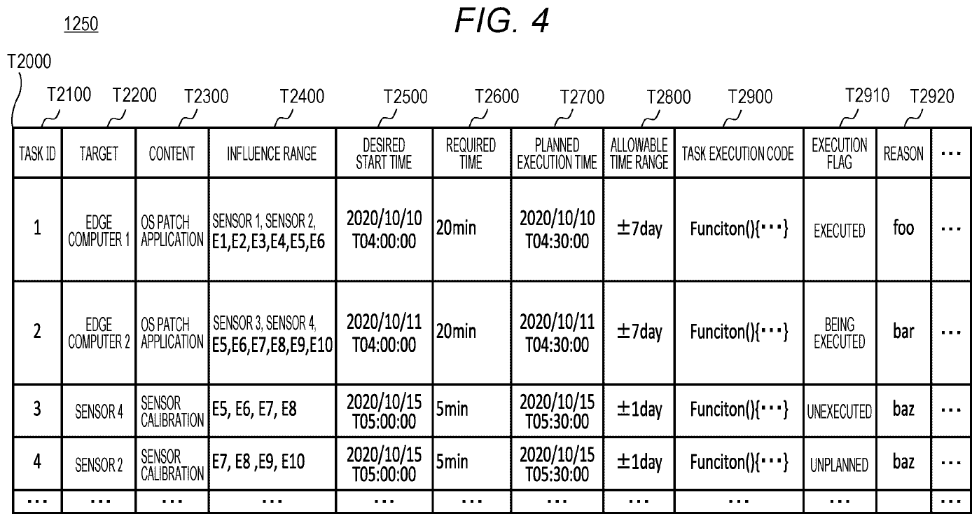

FIG. 4 is a diagram illustrating an example of the task information 1250. The task information 1250 includes, for example, a task table T2000.

The task table T2000 includes information on the tasks to be executed for the edge computers 2100 and the sensors 2200, and is referred to and updated by the task management program P6000 and the task execution program P7000. Each record of the task table T2000 is set for each task, and has information corresponding to each column of a task ID T2100, a target T2200, a content T2300, an influence range T2400, a desired start time T2500, a required time T2600, a planned execution time T2700, an allowable time range T2800, a task execution code T2900, an execution flag T2910, and a reason T2920.

The task ID T2100 is an identifier for uniquely identifying each task represented by the task table T2000. The tasks planned to be executed for the edge computers 2100 and the sensors 2200 are given a series of numbers in advance. Information of the number given to each task is stored in the task ID T2100.

The target T2200 is information indicating a target for executing the task. When the content of the task is update processing of the edge computer 2100, for example, the application of the OS security patch to the edge computer 2100, the identifier of the edge computer as an execution target of the task is described in the target T2200. The identifier of the edge computer described here is the same as the identifier described in the edge T1200 in the configuration table T1000 illustrated in FIG. 3. Further, when the content of the task is the calibration processing of the sensor 2200, the identifier of the sensor as the execution target of the task is described in the target T2200. The identifier of the sensor described here is the same as the identifier described in the sensor ID T1100 in the configuration table T1000 illustrated in FIG. 3. Information on the execution target of such a task is stored in the target T2200.

The content T2300 is information indicating the content of the task. For example, when the content of the task is the application of the OS security patch, “OS patch application” is recorded in the content T2300, and when the content of the task is the calibration of the sensor, “sensor calibration” is recorded in the content. That is, information indicating processing to be executed as the task for the edge computer 2100 or the sensor 2200 is stored in the content T2300.

The influence range T2400 is information on the devices and the monitored areas that may be influenced when the task is executed. For example, a case where the monitored areas E1, E2, E3, and E4 are monitored by the sensor 1, the monitored areas E3, E4, E5, and E6 are monitored by the sensor 2, and both the sensor 1 and the sensor 2 transmit the acquired sensor information to the service providing computer 1100 and the field operation computer 1200 through the edge computer 1 is considered. In this case, when the OS patch is applied to the edge computer 1 as the task 1, the sensor 1 and the sensor 2, and all the monitored areas monitored by these sensors are influenced. Thus, in the example of FIG. 4, in the record of the task 1, “sensor 1, sensor 2, E1, E2, E3, E4, E5, E6” is described in the influence range T2400.

The desired start time T2500 is information on a time at which the execution of the task is desired to be started. For example, the information on the task execution start time designated by the system administrator is expressed in ISO 8601 format or other format and is stored in the desired start time T2500.

The required time T2600 is information on a time required to execute the task. For example, when it takes 20 minutes to apply the OS patch, information such as “20 min” is recorded in the required time T2600. Note that, the calculation of a value of the required time T2600 may be performed by using information officially announced by an OS vendor, or a time at which the same task is executed in the past may be recorded and referred to. Further, the required time may be calculated by using a statistical method, and any method other than this statistical method may be used as long as the required time can be calculated.

The planned execution time T2700 is information on a time at which the task is planned to be executed, and is expressed in, for example, ISO 8601 format or other formats similarly to the desired start time T2500. The planned execution time of the task is determined by the task management program P6000 to be described later. Note that, when the planned execution time of the task is not determined, a value that can be discriminated not to be determined may be recorded in the planned execution time T2700, for example, the planned execution time T2700 of the record is blank.

The allowable time range T2800 is information indicating a range of a time allowed until the task is executed when the task is not executable at the desired time indicated by the desired start time T2500. For example, when the task is the application of the OS patch and the execution of the task is allowed for 7 days before and after the desired start time, “±7 day” or the like is recorded in the allowable time range T2800. Note that, any other description method may be used as long as the format indicates the allowable time range. Further, the value of the allowable time range may be designated by, for example, the system administrator via a predetermined user interface, or may be automatically described from information on past actual results.

The task execution code T2900 is information indicating a code for the computer required to execute the task, and includes, for example, a command group for executing the update processing of the edge computer 2100 such as OS patch application and a command group for executing the calibration processing of the sensor 2200. Note that, the content of the task execution code may be in a programming language format that can be read by the user or in a machine language. Further, any other expression format may be used as long as the task is executable.

The execution flag T2910 is a flag value indicating whether or not the task is executed, and “executed” is recorded when the task is executed, and “unexecuted” is recorded when the task is unexecuted. Note that, when a timing at which the task is executed is not determined by the task management program P6000, such as when the planned execution time T2700 is not described, “unplanned” or the like may be recorded in the execution flag T2910.

The reason T2920 is information indicating a reason when the execution timing of the task cannot be determined. As will be described later, although the execution timing of the task is determined by the task management program P6000, the execution timing may not be determined for some reason at this time. In such a case, the reason is described in the reason T2920 and, is presented to the user via a predetermined user interface as needed.

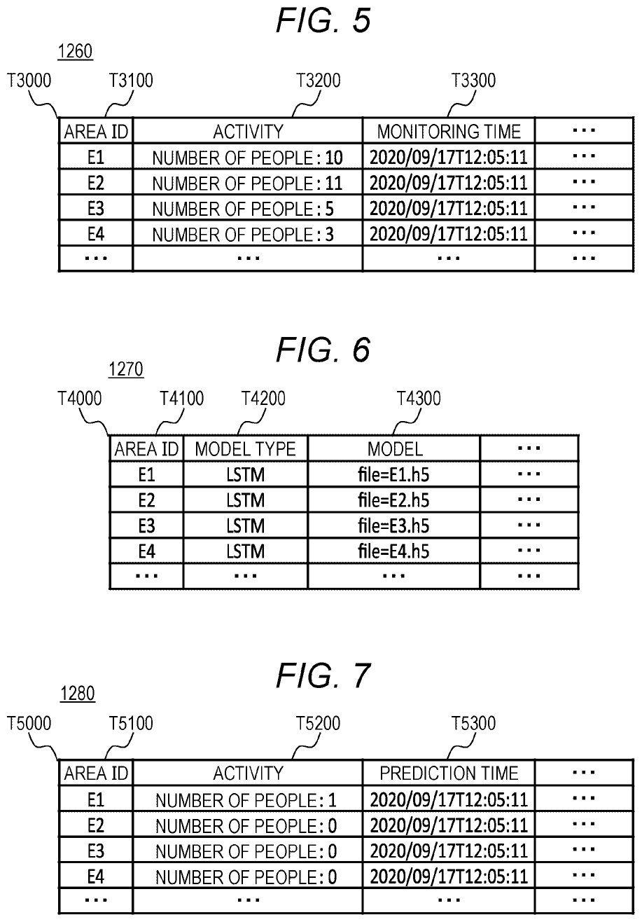

FIG. 5 is a diagram illustrating an example of the field status history information 1260. The field status history information 1260 includes, for example, a field status history table T3000.

The field status history table T3000 includes information on the activities of the monitored areas 2300. As described above, the activity of the monitored area 2300 is information indicating the degree to which the status in which the sensor information is not collectable from the sensor 2200 influences the monitoring of the monitored area 2300, and is expressed by, for example, a degree to which people come and go. The field status history table T3000 is updated by the field status monitoring program P3000 and is referred to by the field status prediction program P5000. Each record of the field status history table T3000 is set for each monitored area 2300, and has information corresponding to each column of an area ID T3100, an activity T3200, and a monitoring time T3300.

The area ID T3100 is an identifier for uniquely identifying each monitored area 2300, and corresponds to the identifier stored in the monitored area T1300 of the configuration table T1000 and the area ID T1510 of the monitored area table T1500 illustrated in FIG. 3. That is, information indicating the unique identifier such as “E1” or “E2” given to each monitored area 2300 in advance according to the above-mentioned area division is stored in the area ID T3100.

The activity T3200 is information indicating the activity of the monitored area 2300, and expresses, for example, the number of people present in the monitored area 2300 at a specific time. Note that, the information on the activity may be the number of people present in the monitored area 2300 at a specific time as in the present embodiment, or may be other information, for example, a change value obtained from a difference from an immediately preceding state or a rate of change in a value. The activity can be expressed by any information as long as information can determine the degree to which the status in which the sensor information is not collectable by the sensor 2200 influences the monitoring of the monitored area 2300.

The monitoring time T3300 is information indicating a time at which the sensor 2200 acquires the sensor information used for generating the information described in the activity T3200, and is expressed in, for example, ISO 8601 format or other formats.

FIG. 6 is a diagram illustrating an example of the field status prediction model 1270. The field status prediction model 1270 includes, for example, a field status prediction model table T4000.

The field status prediction model table T4000 includes information on a prediction model for predicting the activity of the monitored area 2300. The field status prediction model table T4000 is updated by the field status monitoring program P3000 and is referred to by the field status prediction program P5000. Each record of the field status prediction model table T4000 is set for each monitored area 2300, and has information corresponding to each column of an area ID T4100, a model type T4200, and a model T4300.

The area ID T4100 is an identifier for uniquely identifying each monitored area 2300, and corresponds to the area ID stored in the monitored area T1300 of the configuration table T1000 and the area ID T1510 of the monitored area table T1500 illustrated in FIG. 3 similarly to the area ID T3100 in the field status history table T3000 of FIG. 5. That is, information indicating the unique identifier such as “E1” or “E2” given to each monitored area 2300 in advance according to the above-mentioned area division is stored in the area ID T4100.

The model type T4200 indicates a type of the prediction model used by the field status prediction program P5000 to predict a future activity of the monitored area 2300. For example, when the activity is predicted by using a long short-term memory (LSTM) which is one of deep learning models, “LSTM” or the like is recorded in the model type T4200.

The model T4300 indicates information on the prediction model used by the field status prediction program P5000 to predict the future activity of the monitored area 2300, and for example, a name and reference information of a file describing the prediction model is recorded. Note that, the file of the prediction model may be stored in the memory 1410 or the storage device 1440 in the field operation computer 1200, or a file stored in another computer may be acquired. Further, file data itself of the prediction model may be recorded instead of the name and the reference information of the file.

FIG. 7 is a diagram illustrating an example of the field status prediction information 1280. The field status prediction information 1280 includes, for example, a field status prediction table T5000.

The field status prediction table T5000 includes information on a predicted value of the activity of the monitored area 2300. The field status prediction table T5000 is updated by the field status prediction program P5000 and is referred to by the task management program P6000. Each record of the field status prediction table T5000 is set for each monitored area 2300, and has information corresponding to each column of an area ID T5100, an activity T5200, and a prediction time T5300.

The area ID T5100 is an identifier for uniquely identifying each monitored area 2300, and corresponds to the area ID stored in the monitored area T1300 of the configuration table T1000 and the area ID T1510 of the monitored area table T1500 illustrated in FIG. 3 similarly to the area ID T3100 in the field status history table T3000 of FIG. 5 and the area ID T4100 in the field status prediction model table T4000 of FIG. 6. That is, information indicating the unique identifier such as “E1” or “E2” given to each monitored area 2300 in advance according to the above-mentioned area division is stored in the area ID T4100.

The activity T5200 is information indicating the predicted value of the activity of the monitored area 2300, and expresses, for example, a predicted value of the number of people present in the monitored area 2300 at a specific time in the future. Note that, similarly to the activity T3200 in the field status history table T3000 of FIG. 5, the information on the activity may be the number of people present in the monitored area 2300 at a specific time as in the present embodiment, or may be other information, for example, a change value obtained from a difference from an immediately preceding state or a rate of change in a value. The predicted value of the activity can be expressed by any information as long as information can determine the degree to which the status in which the sensor information is not collectable by the sensor 2200 influences the monitoring of the monitored area 2300.

The predicted time T5300 is information indicating a time in the future for which the predicted value of the activity described in the activity T5200 is calculated, and is expressed in, for example, ISO 8601 format or other formats. Note that, the predicted time T5300 may be expressed in a time range instead of a specific time.

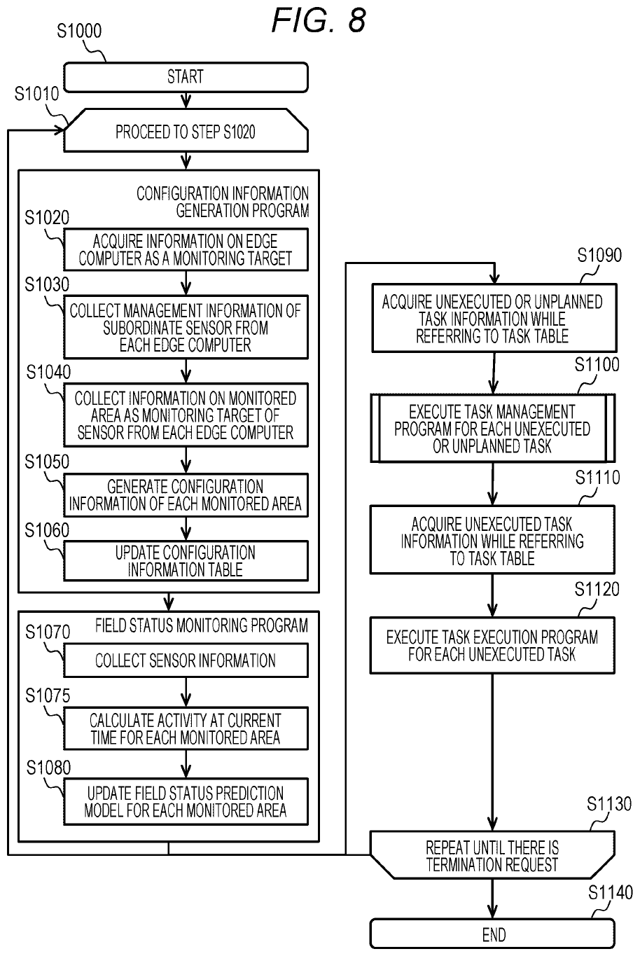

FIG. 8 is a flowchart illustrating a flow of overall processing of the field operation computer 1200. The processing illustrated in the flowchart of FIG. 8 is performed by the CPU 1420 executing the field operation program P1000.

The field operation program P1000 starts the processing in step S1000 and proceeds to step S1010.

In step S1010, the processing proceeds to next step S1020, and loop processing of steps S1020 to S1120 is started.

The processing of steps S1020 to S1060 is performed by the CPU 1420 executing the configuration information generation program P2000 and functioning as the field operation unit 1210. This processing may be performed automatically or manually in response to instructions from the system administrator.

In step S1020, the configuration information generation program P2000 is started, and the field operation computer 1200 acquires the information for accessing the edge computer 2100 as a management target. The information acquired here is, for example, an Internet Protocol (IP) address, a Uniform Resource Identifier (URI), or the like, and is stored and retained in the data management unit 1230. Note that, other information may be acquired as long as information can establish communication with the edge computer 2100.

In step S1030, the field operation computer is connected to each edge computer 2100 by using the information acquired in step S1020, and collects, as the management information of each subordinate sensor 2200, the ID of each subordinate sensor 2200, and information for accessing each sensor 2200, for example, information such as an IP address and a URI from each edge computer 2100. Note that, the management information may be retained by the data management unit 1230, and in this case, the management information is collected from the data management unit 1230. After the management information of each sensor subordinate to the edge computer 2100 is collected, the processing proceeds to step S1040.

In step S1040, the information of the monitored area 2300 as the monitoring target is collected by each subordinate sensor 2200 for each edge computer 2100 based on the management information of the edge computer 2100 and the subordinate sensors 2200 collected in steps S1020 and S1030. That is, area information indicating the monitored area 2300 as the monitoring target by each sensor 2200 belonging to the edge computer 2100 is acquired for each edge computer 2100. After necessary information is collected, the processing proceeds to step S1050.

In step S1050, the configuration information 1240 illustrating a relationship between the edge computer 2100, the sensor 2200, and the monitored area 2300 is generated based on the information collected in steps S1020 to S1040.

In step S1060, the configuration information 1240 generated in step S1050 is reflected to the data management unit 1230, and the configuration information 1240 is updated. For example, as described with reference to FIG. 3, the configuration information 1240 includes the configuration table T1000 and the monitored area table T1500, and when the sensor 2200 is newly installed, a new record corresponding to the sensor is added to the configuration table T1000. On the other hand, when there is no change from the existing system configuration, the configuration table T1000 and the monitored area table T1500 are updated based on the collected information. As a result, the configuration information 1240 stored in the data management unit 1230 is updated based on the area information for each monitored area acquired in step S1040. After the generated configuration information 1240 is reflected to the data management unit 1230, the processing proceeds to step S1070.

The processing of steps S1070 to S1080 is performed by the CPU 1420 executing the field status monitoring program P3000 and functioning as the field operation unit 1210.

In step S1070, the field status monitoring program P3000 is started to collect the sensor information transmitted from each sensor 2200. Here, the sensor information is collected by receiving the sensor information transmitted from each sensor 2200 via the edge computer 2100 to which the sensor 2200 belongs.

In step S1075, an activity at a current time is calculated for each monitored area 2300 based on the sensor information collected from each sensor in step S1070. Here, the activity of each monitored area is determined by associating the sensor information collected in step S1070 with each monitored area 2300 based on the configuration information 1240 updated in step S1060. As a result, the activity for each monitored area can be acquired based on the sensor information collected from each sensor 2200.

In step S1080, the field status history information 1260 is generated from the activity obtained for each monitored area in step S1075. The prediction model such as the above-mentioned LSTM is generated based on the obtained field status history information 1260, for example or the generated prediction model is updated, and the field status prediction model stored in the data management unit 1230 is reflected to the field status prediction model 1270. As a result, the data management unit 1230 updates the content of the field status prediction model 1270. Note that, the field status prediction model 1270 may be updated whenever the sensor information is collected from the sensor 2200, or may be updated periodically, for example, once a day. Further, learning data used to generate the field status prediction model 1270 is not limited to the data based on the sensor information from the sensor 2200, such as the activity recorded in the field status history information 1260. For example, weather information at this time may be added to the learning data as additional information.

In step S1090, task information indicating an unexecuted or unplanned task is acquired while referring to the task information 1250. Here, for example, in the task table T2000 of FIG. 4, the task information indicating the unexecuted or unplanned task is acquired by extracting the record recorded as “unexecuted” or “unplanned” in the execution flag T2910. After the task information is acquired, the processing proceeds to step S1100.

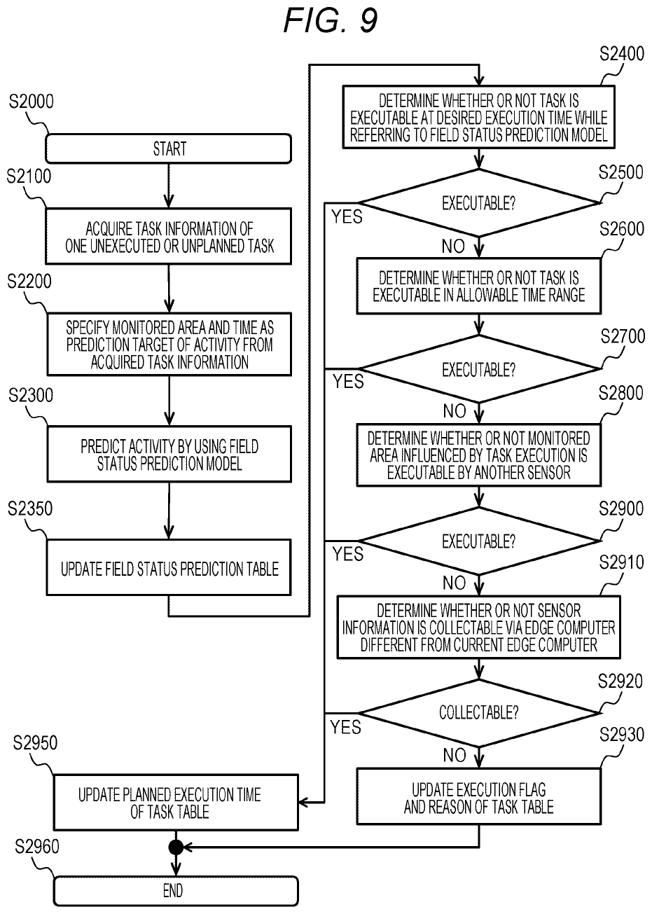

In step S1100, the task management program P6000 is executed for each unexecuted or unplanned task based on the task information obtained in step S1090. Here, the acquired task information is delivered to the task management program P6000, the task management program P6000 is executed, and the processing proceeds to step S1110. Note that, the details of the task management program P6000 executed in step S1100 will be described later with reference to FIG. 9.

In step S1110, the task information indicating the unexecuted task is acquired while referring to the task information 1250 updated by executing the task management program P6000 in step S1100. Here, for example, in the task table T2000 of FIG. 4 in which the task management program P6000 is executed, the task information indicating the unexecuted task is acquired by extracting the record recorded as “unexecuted” in the execution flag T2910. After the task information is acquired, the processing proceeds to step S1120.

In step S1120, the task execution program P7000 is executed for each unexecuted task based on the task information obtained in step S1110. As a result, the task for each edge computer 2100 and each sensor 2200 is executed according to the timing determined by the task management program P6000. After the task execution program P7000 is executed for all the unexecuted tasks, the processing proceeds to step S1130.

In step S1130, it is determined whether or not there is a request for termination of the field operation program P1000. When there is no termination request, the processing returns to step S1010, and the loop processing of steps S1020 to S1120 is repeated. When there is the termination request, the processing proceeds to step S1140, and the processing illustrated in the flowchart of FIG. 8 is terminated.

FIG. 9 is a flowchart illustrating a flow of processing of the task management unit 1220 of the field operation computer 1200. The processing illustrated in the flowchart of FIG. 9 is performed by the CPU 1420 executing the task management program P6000 in step S1100 of FIG. 8.

The task management program P6000 starts the processing in step S2000 and proceeds to step S2010.

In step S2100, the task information for one task of the task information for each unexecuted or unplanned task delivered from the field operation program P1000 is acquired, and the processing proceeds to step S2200.

In step S2200, the monitored area 2300 and the time as a prediction target of the activity are specified from the task information acquired in step S2100. Here, for example, in the record extracted from the task table T2000 of FIG. 4, an execution task device of the task, that is, the edge computer 2100 or the sensor 2200 in which the task is executed is specified from the information illustrated in the target T2200. The monitored area influenced by the execution of the task (hereinafter, referred to as a “task-influenced monitored area”) is specified by specifying the monitored area 2300 corresponding to the specified edge computer 2100 and sensor 2200 based on the configuration information 1240. As a result, the monitored area 2300 corresponding to each sensor 2200 belonging to the edge computer 2100 of which the update processing is executed in the task, or the monitored area 2300 corresponding to the sensor 2200 of which the calibration processing is executed in the task can be specified as the task-influenced monitored area. When the task-influenced monitored area can be specified in this manner, the task-influenced monitored area is set as the monitored area 2300 as a prediction target of the activity, and the information of the influence range T2400 of the record included in the task table T2000 is updated.

Note that, when the processing of collecting and fabricating the sensor information via the edge computer 2100 is not influenced, such as the application of the patch without restarting the edge computer 2100 or stopping the function, it may be determined that there is task-influenced monitored area. In this case, in the task table T2000, the influence range T2400 corresponding to the task may be blank or the like.

Further, for example, in the record extracted from the task table T2000 of FIG. 4, a range of a date and time when the task is executable is specified from the information illustrated in the desired start time T2500, the required time T2600, and the allowable time range T2800. As a result, it is possible to specify a time as a prediction target of the activity.

As described above, when the monitored area 2300 and the time as the prediction target of the activity can be specified in step S2200, the processing proceeds to step S2300.

In step S2300, the activity for the monitored area 2300 and time specified in step S2200 is predicted by using the field status prediction model 1270. Here, for example, in the field status prediction model table T4000 of FIG. 6, the prediction model corresponding to the task-influenced monitored area as the prediction target of the activity is acquired from the model T4300. The activity is predicted by calculating the activity of the monitored area 2300 at a time in the future as the prediction target of the activity by using the acquired prediction model. Such processing is performed for each task-influenced monitored area specified as the prediction target of the activity in step S2200, and thus, it is possible to calculate the predicted value of the activity at a time in the future at which the task is executable for each monitored area 2300 influenced by the execution of the task. That is, it is possible to predict a degree to which each monitored area 2300 is influenced by the execution of the task.

In step S2350, the field status prediction information 1280 is updated based on the predicted value of the activity calculated in step S2300. Here, for example, in the field status prediction table T5000 of FIG. 7, the values of the activity T5200 and the predicted time T5300 are updated by reflecting the prediction result of the activity obtained in step S2300. As a result, it is possible to generate the field status prediction information 1280 by predicting the future activity of each monitored area 2300. After the field status prediction information 1280 is updated, the processing proceeds to step S2400.

In step S2400, it is determined whether or not the task is executable at a desired execution time of the task while referring to the field status prediction information 1280 updated in step S2350. Here, for example, the predicted value of the activity of the task-influenced monitored area at that time is acquired from the activity T5200 of the field status prediction table T5000 while referring to the desired start time T2500 of the record corresponding to the task in the task table T2000. The acquired predicted value of the activity is compared with a predetermined threshold value, and when the predicted value is equal to or less than the threshold value, it is determined that the task is executable. When the determination result of whether or not the task is executable is obtained in this manner, the processing proceeds to step S2500. For the threshold value used for this determination, for example, “0” is set as a value indicating that there is no people coming and going in the task-influenced monitored area. Alternatively, as long as a value does not have a problem in executing the task involving restarting or stopping the sensor 2200 that monitors the monitored area 2300 or the edge computer 2100 that relays the sensor information, another value may be set to the threshold value. Further, the threshold value may be manually determined by the system administrator or the service user, or may be automatically determined from the past results.

In step S2500, branch processing based on the determination result of step S2400 is performed. Here, when it is determined in step S2400 that the task is executable, the processing proceeds to step S2950, and when it is determined that the task is not executable, the processing proceeds to step S2600.

In step S2600, it is determined whether or not the task is executable within the allowable time range for the execution of the task while referring to the field status prediction information 1280 updated in step S2350. Here, for example, the predicted value of the activity of the task-influenced monitored area in the date and time range specified from this information is acquired from the activity T5200 of the field status prediction table T5000 while referring to the desired start time T2500 and the allowable time range T2800 of the record corresponding to the task in the task table T2000. The acquired predicted value of the activity is compared with a predetermined threshold value, and when there is a time zone in which the activity is equal to or less than a threshold value, it is determined that the task is executable. When the determination result of whether or not the task is executable is obtained in this manner, the processing proceeds to step S2700. Note that, in the determination of step S2600, the same threshold value as in step S2400 described above can be used.

In step S2700, the branch processing based on the determination result of step S2600 is performed. Here, when it is determined in step S2600 that the task is executable, the processing proceeds to step S2950, and when it is determined that the task is not executable, the processing proceeds to step S2800.

In step S2800, it is determined whether or not the task-influenced monitored area specified in step S2200 is monitorable by the plurality of sensors 2200 based on the configuration information 1240. Here, for example, it is determined whether or not there are a plurality of sensors 2200 of which the monitoring target is the monitored area based on the information described in the monitored area T1300 of the configuration table T1000. As a result, it is possible to determine whether or not the monitored area is monitorable by the plurality of sensors 2200. For example, in FIG. 1, a case where the execution target of the task is the edge computer 1 or the sensor 2 and the monitored area E6 is the task-influenced monitored area is considered. In this case, from the configuration table T1000 in FIG. 3, it can be seen that the monitored area E6 is monitored by the sensor 3 in addition to the sensor 2 for the reason of accuracy improvement and redundancy. Accordingly, it is possible to determine that the monitored area E6 is monitorable by the sensor 3 and the sensor information related to the monitored area E6 can be interpolated even though the task is being executed for the edge computer 1 or the sensor 2. By doing this, when the determination result of whether or not the task is executable is obtained in step S2800, the processing proceeds to step S2900.

In step S2900, the branch processing based on the determination result of step S2800 is performed. Here, when it is determined in step S2800 that the task-influenced monitored area is monitorable by the plurality of sensors 2200, the processing proceeds to step S2950, and when it is determined that the task-influenced monitored area is not monitorable, the processing proceeds to step S2910. Note that, when the processing proceeds from step S2900 to S2950 and when the task is being executed for the sensor 2200, it is preferable that information for causing the task not to be executed for another sensor 2200 of which the monitoring target is the same monitored area 2300 as the sensor 2200 is reflected to the task information 1250. For example, in the task table T2000, the task information 1250 can be reflected by excluding the planned execution time of the task from the allowable time range T2800 of the other target sensor 2200.

In step S2910, when the execution target of the task is the edge computer 2100, it is determined that the sensor information from the sensor 2200 of which the monitoring target is the monitored area is collectable via another edge computer 2100 based on the configuration information 1240 for the task-influenced monitored area specified in step S2200. Here, for example, the current edge computer 2100 that manages the sensor 2200 is specified from the relationship between the sensor ID T1100 and the edge T1200 in the configuration table T1000, and it is determined whether or not the sensor 2200 can be temporarily managed in the edge computer 2100 while the task is being executed for the edge computer 2100. For this determination, for example, additional information such as a processing load of each edge computer can be used. For example, in FIG. 1, a case where the edge computer 1 is the execution target of the task and it is necessary to stop the edge computer 1 in order to execute the task is considered. In this case, when the management of the sensor 1 can be temporarily delegated to the edge computer 2, it is possible to determine that the task is executable. By doing this, when the determination result of whether or not the sensor information is collectable by another edge computer is obtained in step S2910, the processing proceeds to step S2920.

In step S2920, the branch processing based on the determination result of step S2910 is performed. Here, when it is determined in step S2910 that the sensor information is collectable by another edge computer, the processing proceeds to step S2950, and when it is determined that the sensor information is not collectable, the processing proceeds to step S2930. Note that, when the processing proceeds from step S2920 to S2950, it is preferable that a correspondence between the edge computer 2100 and the sensor 2200 which are the execution targets of the task is changed and information for collecting the sensor information of the task-influenced monitored area via the other edge computer 2100 is reflected to the task information 1250. For example, the task information 1250 can be reflected by adding a command to delegate a management authority of the sensor 2200 to the task execution code T2900 of the record corresponding to the task in the task table T2000.

In step S2930, the reason why the task is not executable is recorded in the task information 1250. Here, for example, the fact that it is not possible to cope with even a case where people come and go at the desired execution time of the task, there is no timing at which the task is executable even within the range of the allowable execution time, and the configuration of the edge computer 2100 that manages the sensor 2200 is changed is recorded in the reason T2920 in the task table T2000. Thereafter, the processing proceeds to step S2960, and the processing illustrated in the flowchart of FIG. 9 is terminated.

In step S2950, the task information 1250 is updated based on the processing results of steps S2400 to S2920. Here, for example, the planned execution time T2700 is updated in the task table T2000, and the execution flag T2910 is updated to “planned”. As a result, a timing at which the task is executed can be controlled such that a time when the activity for the task-influenced monitored area is less than a predetermined value is predicted and the task is executed for at least one of the edge computer 2100 and the sensor 2200 corresponding to the task-influenced monitored area at the predicted time. Thereafter, the processing proceeds to step S2960, and the processing illustrated in the flowchart of FIG. 9 is terminated.

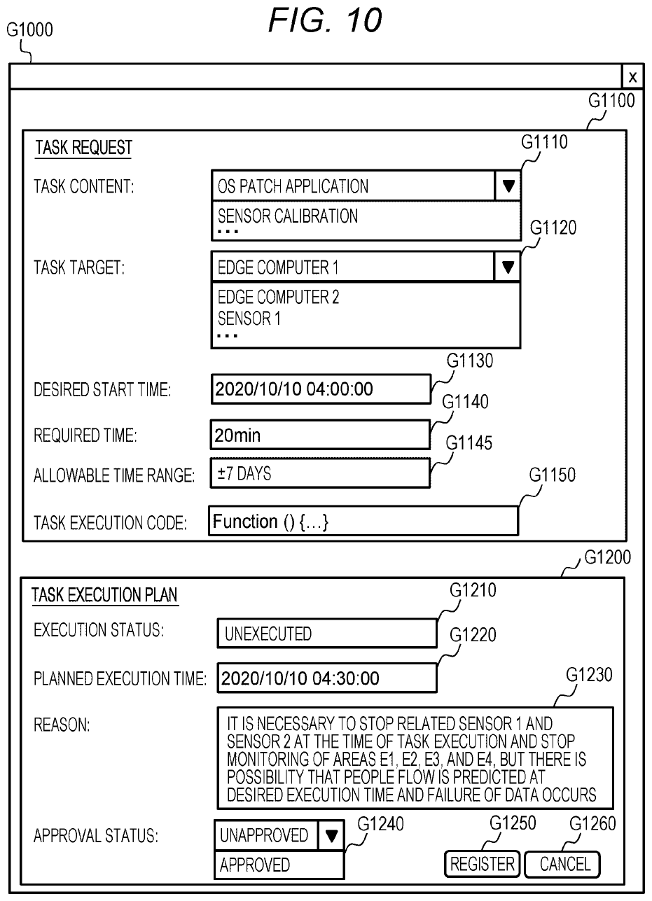

FIG. 10 is a diagram illustrating an example of a task management screen provided by the field operation computer 1200. The CPU 1420 executes the IF program P4000, and thus, the task management screen of FIG. 10 is displayed on a display device of the input and output I/F 1430 and other computers.

A task management screen G1000 includes a task request field G1100 for the system administrator to input information about the task, and a task execution plan field G1200 for showing the result of the task execution plan determined by the field operation program P1000 and the task management program P6000.

The task request field G1100 includes a task content G1110, a task target G1120, a desired start time G1130, a required time G1140, an allowable time range G1145, and a task execution code G1150.

The task content G1110 is an input field for designating the content of the task, and has options such as “OS patch application” and “sensor calibration”. These options correspond to the content T2300 of the task table T2000.

The task target G1120 is an input field for designating a device as an execution target of the task, and has options such as “edge computer 1”, “edge computer 2”, “sensor 1”, and “sensor 2”. These options correspond to the target T2200 of the task table T2000.

The desired start time G1130 is an input field for designating a desired time for executing the task. The time designated here corresponds to the desired start time T2500 of the task table T2000.

The required time G1140 is an input field for designating a required time for executing the task. The required time designated here corresponds to the required time T2600 of the task table T2000.

The allowable time range G1145 is an input field for designating a range of a time at which the execution of the task is allowed at another timing when the task cannot be started at the time designated by the desired start time G1130. The time range designated here corresponds to the allowable time range T2800 of the task table T2000.

The task execution code G1150 is an input field for designating the task to be executed. The information designated here corresponds to the task execution code T2900 of the task table T2000, and may be designated in, for example, a programming language.

The task execution plan field G1200 includes an execution status G1210, a planned execution time G1220, a reason G1230, an approval status G1240, a registration button G1250, and a cancel button G1260.

The execution status G1210 is a display field indicating an execution status of the task. The information displayed here corresponds to the execution flag T2910 of the task table T2000.

The planned execution time G1220 is a display field indicating a planned execution time of the task. The time displayed here corresponds to the planned execution time T2700 of the task table T2000.

The reason G1230 is a display field indicating a reason for hindering the execution of the task. The information displayed here corresponds to the reason T2920 in the task table T2000.

The approval status G1240 is a display field for indicating an approval status of the system administrator for the execution plan of the task indicated by the execution status G1210, the planned execution time G1220, and the reason G1230. The system administrator can indicate an intention of whether or not to approve the execution plan determined for each task by using this approval status G1240.

The registration button G1250 is an operation button for reflecting the information input in the task request field G1100 in the task table T2000. The system administrator can reflect the information in the task table T2000 by operating the registration button G1250 after the necessary information is input in each input field of the task request field G1100.

The cancel button G1260 is an operation button for canceling an input operation on the task management screen G1000. Even when the content of the task request field G1100 or the task execution plan field G1200 are changed by mistake, the system administrator can cancel the reflection of the changed content to the task table T2000 by operating the cancel button G1260.

Note that, the task management screen G1000 illustrated in FIG. 10 is an example of a screen used by the system administrator to manage the task, and may be another screen content. When the IF program P4000 is executed on the CPU 1420, the field operation unit 1210 can display any task management screen including at least one of the content of the task, the execution target, the execution condition, the execution status, the planned execution time, and the non-execution reason on the display device. As a result, the system administrator can easily manage the tasks.

According to one embodiment of the present invention, the execution timing of the task for the sensor or the edge computer and the combination of the sensor and the edge computer can be appropriately controlled such that the task is executed while the monitoring ability of the sensor installed in the field is maintained by performing the above series of processing. Thus, even in an environment where it is not possible to dynamically change the relationship between the sensor and the edge computer due to the specifications, it is possible to execute the task while the influence on the service provision such as the people flow analysis using the sensor is suppressed.

According to the above-described embodiment of the present invention, the following effects can be obtained.

(1) The field operation computer 1200 that is a computer system includes the field operation unit 1210 that performs the operation management of one or the plurality of sensors 2200 installed in the field 2000 having one or the plurality of monitored areas 2300 in order to monitor the monitored area 2300 in the field 2000, the task management unit 1220 that manages the task to be executed for the sensor 2200, and the data management unit 1230 that retains the configuration information 1240 indicating the relationship between the sensor 2200 and the monitored area 2300. The field operation unit 1210 collects the acquired sensor information in order to monitor the monitored area 2300 by the sensor 2200 (step S1070). The task management unit 1220 generates the field status prediction information 1280 including the prediction information of the activity indicating the degree to which the status in which the sensor information is not collectable from the sensor 2200 influences the monitoring of the monitored area 2300 (step S2350), and controls the timing at which the task is executed based on the field status prediction information 1280 and the configuration information 1240 (steps S2400 to S2950). By doing so, it is possible to appropriately control the timing at which the task is executed for the sensor installed in the field.

(2) One or a plurality of edge computers 2100 for transmitting the sensor information acquired by the sensor 2200 to the field operation computer 1200 is provided in the field 2000. The task includes at least one of the update processing for updating the edge computer 2100 and the calibration processing for calibrating the sensor 2200. By doing so, it is possible to execute, as the task, the processing such as security measures and maintenance works necessary for the operation of the IoT system 100 installed in the field at an appropriate timing.

(3) The task management unit 1220 specifies, as the task-influenced monitored area influenced by the execution of the task, at least one of the monitored area 2300 corresponding to each sensor 2200 belonging to the edge computer 2100 in which the update processing is executed and the monitored area 2300 corresponding to the sensor 2200 in which the calibration processing is executed based on the configuration information 1240 (step S2200). By doing so, the monitored area 2300 which is appropriate as the control target of the task execution timing can be specified as the task-influenced monitored area.

(4) The task management unit 1220 controls the timing at which the task is executed such that the time at which the activity for the task-influenced monitored area is less than the predetermined value is predicted based on the field status prediction information 1280 and the task is executed for at least one of the edge computer 2100 and the sensor 2200 corresponding to the task-influenced monitored area at the predicted time (step S2950). By doing so, it is possible to execute the task for the edge computer 2100 or the sensor 2200 at an appropriate timing such that the influence of the task execution on each monitored area is suppressed to a desired degree or less.

(5) The data management unit 1230 retains the task information 1250 including the allowable time range indicating the time range in which the execution of the task is allowed. The task management unit 1220 controls the timing at which the task is executed based on the allowable time range in the task information (steps S2600, S2700, and S2950). By doing so, even though the task is not executable at the desired date and time, the task is executable with the timing shifted within the allowable range.

(6) When the task-influenced monitored area is monitorable by the plurality of sensors 2200, the task management unit 1220 controls the timing at which the task is executed such that the task is not executed for the other sensors 2200 when the task is being executed for any of the plurality of sensors 2200 (steps S2800, S2900, and S2950). By doing so, when the sensor information of the monitored area 2300 can be interpolated by another sensor 2200 other than the sensor 2200 which is the execution target of the task, the task is executable at an appropriate timing.

(7) When the update processing is executed for the edge computer 2100 to which the sensor 2200 of which the monitoring target is the task-influenced monitored area belongs, the task management unit 1220 updates the correspondence between the edge computer 2100 and the sensor 2200 such that the sensor information acquired by the sensor 2200 is collected via another edge computer 2100 different from the edge computer 2100, and controls the timing at which the task is executed based on the updated correspondence between the edge computer 2100 and the sensor 2200 (steps S2910, S2920, and S2950). By doing so, when the sensor 2200 can be temporarily managed by another edge computer 2100 other than the edge computer 2100 as the execution target of the task, the task is executable at an appropriate timing.

(8) The field operation unit 1210 acquires the area information indicating the monitored area 2300 that is the monitoring target of each sensor 2200 belonging to the edge computer 2100 for each edge computer 2100 (step S1040), and updates the configuration information 1240 based on the acquired area information (step S1060). By doing so, the configuration information 1240 can be appropriately updated by reflecting the relationship between each sensor 2200 and the monitored area 2300.

(9) The field operation unit 1210 acquires the activity for each monitored area 2300 based on the sensor information collected from the sensor 2200 via the edge computer 2100 (step S1075). The task management unit 1220 predicts the activity in the future for each monitored area 2300 (step S2300), and generates the field status prediction information 1280 (step S2350). By doing so, it is possible to reliably generate the field status prediction information 1280 necessary for controlling the timing at which the task is executed.

(10) In the configuration information 1240, the relationship between the sensor 2200 and the monitored area 2300 is expressed by at least one of two-dimensional coordinates, three-dimensional coordinates, an identifier, or a mathematical formula. By doing so, the relationship between the sensor 2200 and the monitored area 2300 can be appropriately expressed.

(11) The field operation unit 1210 displays the task management screen G1000 including at least one of a content of the task, an execution target, an execution condition, an execution status, a planned execution time, and a non-execution reason on a display device. By doing so, it is possible to provide the user interface required by the system administrator.

Note that, the above-described embodiment and various modification examples are merely examples, and the present invention is not limited to these contents as long as the features of the invention are not impaired. Further, although various embodiments and modification examples have been described above, the present invention is not limited to these contents. Other aspects considered within the scope of the technical idea of the present invention are also included within the scope of the present invention.

1. A computer system comprising:
a field operation unit that performs operation management of one or a plurality of sensors installed in a field having one or a plurality of monitored areas in order to monitor the monitored area in the field;
a task management unit that manages a task to be executed for the sensor; and
a data management unit that retains configuration information indicating a relationship between the sensor and the monitored area, wherein
the field operation unit collects sensor information acquired in order to monitor the monitored area by the sensor, and
the task management unit that generates field status prediction information including prediction information of an activity indicating a degree to which a status in which the sensor information is not collectable from the sensor influences the monitoring of the monitored area, and controls a timing at which the task is executed based on the field status prediction information and the configuration information.

2. The computer system according to claim 1,
wherein
one or a plurality of edge computers for transmitting the sensor information acquired by the sensor to the computer system is provided in the field, and
the task includes at least one of update processing for updating the edge computer and calibration processing for calibrating the sensor.

3. The computer system according to claim 2, wherein
the task management unit specifies, as a task-influenced monitored area influenced by the execution of the task, at least one of the monitored area corresponding to each sensor belonging to the edge computer in which the update processing is executed and the monitored area corresponding to the sensor in which the calibration processing is executed based on the configuration information.

4. The computer system according to claim 3, wherein
the task management unit controls the timing at which the task is executed such that a time at which the activity for the task-influenced monitored area is less than a predetermined value is predicted based on the field status prediction information and the task is executed for at least one of the edge computer and the sensor corresponding to the task-influenced monitored area at the predicted time.

5. The computer system according to claim 3, wherein
the data management unit retains task information including an allowable time range indicating a time range in which the execution of the task is allowed, and
the task management unit controls the timing at which the task is executed based on the allowable time range in the task information.

6. The computer system according to claim 3, wherein
when the task-influenced monitored area is monitorable by the plurality of sensors, the task management unit controls the timing at which the task is executed such that the task is not executed for the other sensors when the task is being executed for any of the plurality of sensors.

7. The computer system according to claim 3, wherein
when the update processing is executed for the edge computer to which the sensor of which a monitoring target is the task-influenced monitored area belongs, the task management unit updates a correspondence between the edge computer and the sensor such that the sensor information acquired by the sensor is collected via another edge computer different from the edge computer, and controls the timing at which the task is executed based on the updated correspondence between the edge computer and the sensor.

8. The computer system according to claim 2, wherein
the field operation unit acquires area information indicating the monitored area that is the monitoring target of each sensor belonging to the edge computer for each edge computer, and updates the configuration information based on the acquired area information.

9. The computer system according to claim 2, wherein
the field operation unit acquires the activity for each monitored area based on the sensor information collected from the sensor via the edge computer, and
the task management unit predicts the activity in the future for each monitored area, and generates the field status prediction information.

10. The computer system according to claim 1, wherein
in the configuration information, a relationship between the sensor and the monitored area is expressed by at least one of two-dimensional coordinates, three-dimensional coordinates, an identifier, or a mathematical formula.

11. The computer system according to claim 1, wherein
the field operation unit displays a task management screen including at least one of a content of the task, an execution target, an execution condition, an execution status, a planned execution time, and a non-execution reason on a display device.

12. A field operation supporting method for supporting operation management of one or a plurality of sensors installed in a field having one or a plurality of monitored areas in order to monitor the monitored area in the field, the method comprising:
retaining configuration information indicating a relationship between the sensor and the monitored area;
generating field status prediction information including prediction information of an activity indicating a degree to which a status in which sensor information is not collectable from the sensor influences the monitoring of the monitored area; and
controlling a timing at which a task related to the sensor is executed based on the field status prediction information and the configuration information.
